(19) United States
(12) Patent Application Publication
(10) Pub. No.: US 2022/0203914 A1
(43) Pub. Date: Jun. 30, 2022

(54) LIGHTED VEHICLE STEP PAD AND VEHICLE LIGHT SOURCE

(71) Applicant: Monsour Baker, Orlando, FL (US)

(72) Inventor: Monsour Baker, Orlando, FL (US)

(21) Appl. No.: 17/569,879

(22) Filed: Jan. 6, 2022

Related U.S. Application Data
(62) Division of application No. 16/170,248, filed on Oct. 25, 2018, now abandoned.
(60) Provisional application No. 62/577,959, filed on Oct. 27, 2017.

(51) Int. Cl. B60R 19/50; B60Q 1/00; B60R 3/00; B60Q 1/30; B60Q 1/26

(52) U.S. Cl. CPC B60R 19/50; B60Q 1/0017; B60R 3/00; B60R 2019/505; B60Q 1/2696; B60Q 1/2661; B60R 3/007; B60Q 1/30

(57) ABSTRACT

A lighted vehicle part includes a vehicle step pad attachable to a vehicle. The step pad has a stepping surface configured to permit a user to step on the stepping surface when loading objects into a vehicle on which the step pad is attached. A downturned lip extends downwardly from the stepping surface. A light source is mounted to the step pad in such a way that the light source can emit light from the lip.

### CROSS-REFERENCE TO RELATED APPLICATION

This application is a divisional of U.S. Non-provisional application Ser. No. 16/170,248, filed Oct. 25, 2018, which claims the benefit of U.S. Provisional Application Ser. No. 62/577,959, filed Oct. 27, 2017, the contents of which applications are hereby incorporated by reference in their entirety.

### FIELD

This relates to the field of motor vehicles and, more particularly, to illuminating parts of motor vehicles.

### BACKGROUND

People customize motor vehicles with lighted accessories as a form of expression and as a safety mechanism. Emergency vehicles such as police cars, fire trucks, and ambulances use lighting accessories to make the vehicle noticeable. Emergency personnel will sometimes install lighting accessories on the front and/or rear bumpers of their vehicles to enhance visibility. Such lighting accessories may include flashing lights that change colors to improve the vehicle's visibility. Conventional bumper lighting systems are often cumbersome and unsightly because wires are showing or the lighting system simply does not mesh with the ornamental appearance of the vehicle.

### BRIEF SUMMARY

Vehicle bumpers often include a step pad that fits atop the bumper to provide a step or a platform where a person can stand while loading and unloading the vehicle. It would be advantageous to have a lighting system installed on a step pad to provide enhanced visibility to the vehicle. Such a lighting system would provide better aesthetics than conventional the systems while enhancing vehicle safety.

In view of this, an example of such a lighted vehicle part includes a vehicle step pad attachable to a vehicle. The step pad has a stepping surface configured to permit a user to step on the stepping surface when loading objects into a vehicle on which the step pad is attached. A downturned lip extends downwardly from the stepping surface and a light source is mounted to the step pad in such a way that the light source can emit light from the lip.

The step pad may be installed on a vehicle having at least one tire, a vehicle body extending from a front end to a rear end and having a bumper extending from the rear end. The step pad is attached to the bumper, forming the stepping surface.

The lip may define at least one opening and a light cover of the light source may be positioned at the at least one opening.

The step pad may include an interior surface and the light source may be mounted on the interior surface.

The light source may be attached to an interior section of the lip with an attachment in such a way that the attachment is not visible on an exterior portion of the lip opposite the interior portion of the lip.

The step pad may have an L-shaped cross-section along a majority of a length of the step pad.

An example of a method of lighting a vehicle part includes forming an opening in a portion of a first vehicle step pad having a stepping surface configured to permit a user to step on the stepping surface when loading objects into a vehicle on which the step pad is attached. The method continues by positioning a light source adjacent the opening so as to emit light from the opening.

The method may include removing a second step pad from the vehicle and replacing the second step pad with the first step pad.

The method may include installing the first step pad onto a vehicle bumper.

An example of a light source may include a housing forming a first channel having an upper planar wall and a lower planar wall, a housing front wall extending vertically between the upper planar wall and lower planar wall, and an open back section opposite the front wall. A light cover is positioned at the housing front wall. An electrical chassis is positioned within the channel. The electrical chassis includes a chassis rear wall that at least partially closes the open back section and a chassis front wall supporting a plurality of LEDs oriented to emit light through the light cover. The electrical chassis forms a second channel within the first channel, the second channel including electronics.

The light cover may be connected directly to the electrical chassis and extend through the housing front wall.

The chassis rear wall may define a wire receiving opening.

The electrical chassis may include an open top section.

The first channel and second channel may both be generally U-shaped.

### BRIEF DESCRIPTION OF THE DRAWINGS

FIG. 1 is an example of a motor vehicle including a step pad.

FIG. 2 is a zoom view of the vehicle's rear bumper.

FIG. 3 is a top perspective view of an example of a lighted step pad.

FIG. 4 is a front plan view thereof.

FIG. 5 is a top plan view thereof.

FIG. 6 is a bottom plan view thereof.

FIG. 7 is a partial cutaway view of the interior of the step pad.

FIG. 8 is a partial cutaway view of the exterior of the step pad.

FIG. 9 is a zoom view of the light source attached to the interior of the step pad with the housing of the light source not shown.

FIG. 10 is a top perspective view of first example of a light source.

FIG. 11 is a front plan view thereof.

FIG. 12 is a rear plan view thereof.

FIG. 13 is bottom plan view thereof.

FIG. 14 is a top plan view thereof.

FIG. 15 is a side plan view thereof.

FIG. 16 is the opposite side plan view thereof.

FIG. 17 is a top perspective view of an electrical chassis that may be used with the light source.

FIG. 18 is a bottom perspective view thereof.

FIG. 19 is a top perspective view of the electrical chassis with the light cover attached.

FIG. 20 is a bottom perspective view thereof.

FIG. 21 is a top view of the electrical chassis with a circuit board installed, which is covered with a waterproofing material.

FIG. 22 is a top front perspective view of a second example of the light source.

FIG. 23 is a top back perspective view thereof.

FIG. 24 is a top front perspective view of a third example of the light source.

FIG. 25 is a top back perspective view thereof.

FIG. 26 is a side perspective view of a fourth example of the light source.

FIG. 27 is a top back perspective view thereof.

FIG. 28 is a block diagram illustrating a control mechanism.

### DETAILED DESCRIPTION OF EXAMPLE EMBODIMENTS

This disclosure describes example features and embodiments, but not all possible features or embodiments of the lighted vehicle step pad and light source. Where a particular feature is disclosed in the context of a particular aspect or embodiment, that feature can also be used, to the extent possible, in combination with and/or in the context of other aspects and embodiments. The lighted vehicle step pad and light source may be embodied in many different forms and should not be construed as limited to only the features and embodiments described here or shown in the drawings.

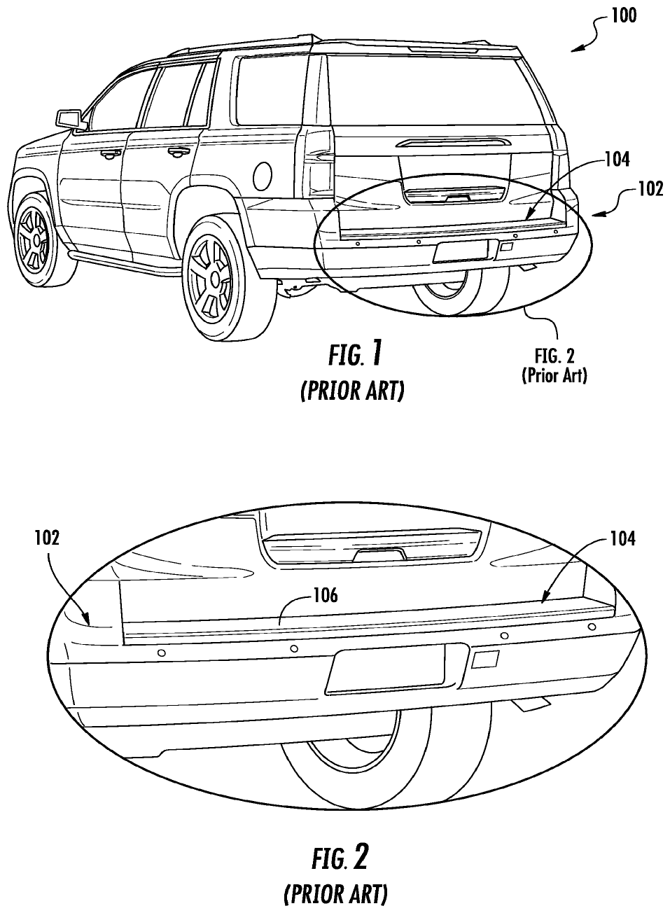

Referring to FIGS. 1 and 2, a vehicle 100 including a rear bumper 102 having a bumper step pad 104 is generally shown. The step pad 104 is affixed at the rear bumper 102. The step pad 104 forms a stepping surface 106 along the top of the bumper 102 that a person can stand or sit on. The step pad 104 protects the top of the bumper 102 from wear and tear when loading and unloading the vehicle's trunk. The step pad 104 may be replaced with the lighted bumper step pad described here.

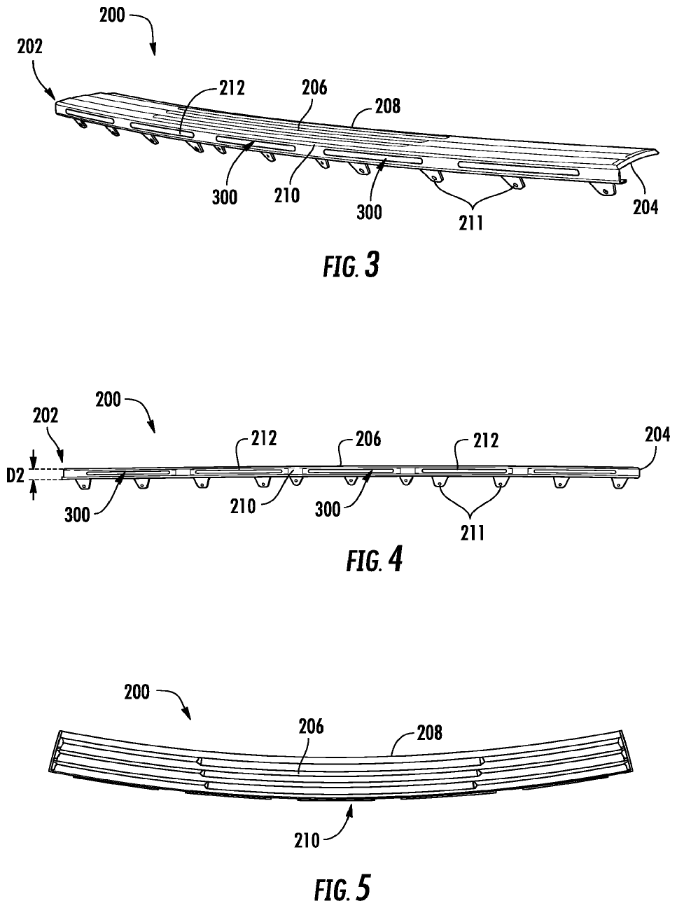

Referring now to FIGS. 3-8, the lighted vehicle step pad 200 includes a body 202 elongated in a vehicle width direction so as to extend across the width of the vehicle on which the step pad 200 is positioned. The body 202 includes an exterior surface 204 that is visible when installed on the vehicle 100. An upper section of the exterior surface 204 forms the stepping surface 206, which extends from a forward terminal edge 208 that is positioned adjacent the rear of the vehicle's body to a lip 210. The lip 210 is downturned relative to the stepping surface 206. A plurality of mounting brackets 211 are positioned about the perimeter of the step pad 200 for attaching the step pad 200 to the vehicle.

The stepping surface 206 may be textured to provide grip and prevent slipping. When installed on a vehicle, the stepping surface 206 provides the user a place to step when loading and/or unloading objects from the vehicle and is generally horizontal and parallel to the underlying ground.

The lip 210 defines a plurality of openings 212 that pass through the lip 210. The openings 212 are configured to allow lights from a light source 300 to shine therethrough. In the example shown in the drawings, the lighted step pad 200 includes five openings 212 and five light sources 300. It is to be understood that the scope of possible configurations is not limited to this example.

An interior surface 214 of the step pad 200 includes a stepping surface interior 216 extending from the forward terminal edge 208 to a lip interior surface 218 forming the interior of the lip 210. When installed on a vehicle, the interior surface 214 is not substantially visible so that most of the light source 300 is hidden from view.

The step pad 200 may be made of a material such as plastic, metal, or the like. In a specific example, the step pad 200 is made of a plastic material that can easily be removed from the vehicle and replaced when desired.

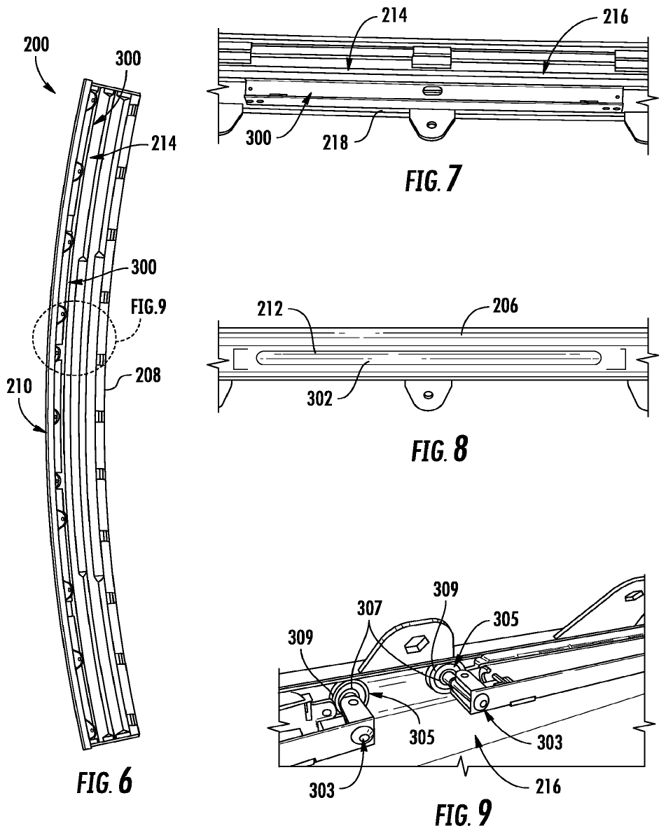

As viewed in FIGS. 6-8, the light source 300 is mounted to the interior surface 214 such that a light cover 302 of the light source is positioned at the opening 212. The light source 300 may be mounted using a fastening mechanism such as an adhesive, one or more screws, or the like.

FIG. 9 shows an example of a mechanism for attaching the light source 300 to the step pad 200. In this example, fasteners 303 are attached to the light source 300 and step pad 200. An affixing end 305 of the fastener includes a flattened head 307. The flattened head 307 is welded to or adhered to the interior surface 216 forming the interior of the lip 210. The weld or adhesive 309 forms a bond between the flattened head 307 and the step pad 200. This construction is advantageous for certain examples because the attachment between the light source 300 and step pad 200 is not visible from the exterior of the step pad 200.

The light cover 302 of the light source 300 may be transparent and/or translucent to allow light to pass through. The material from which the light cover is made may be a plastic or the like. The light cover 302 is provided to provide a protective cover over the light source's lights.

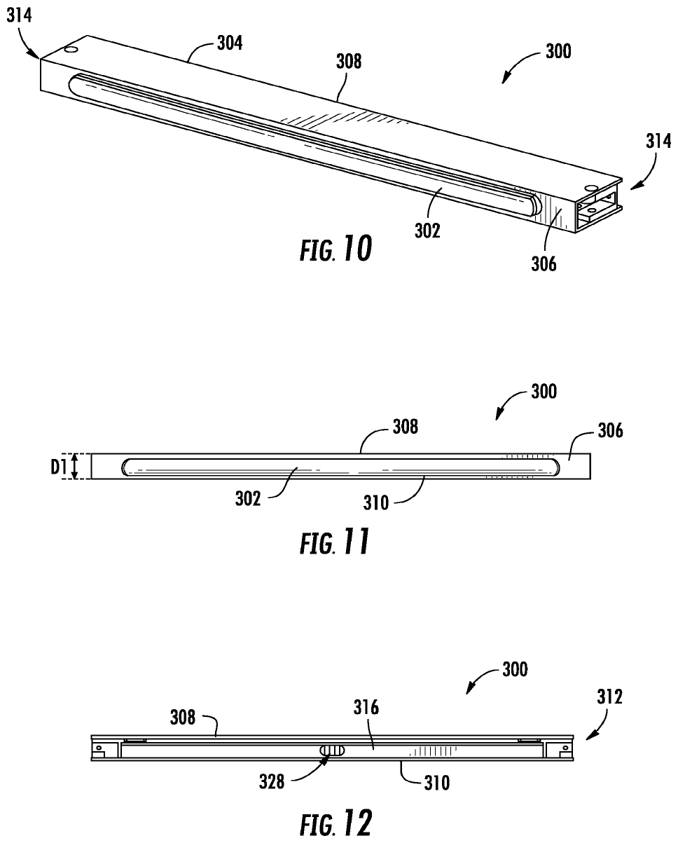

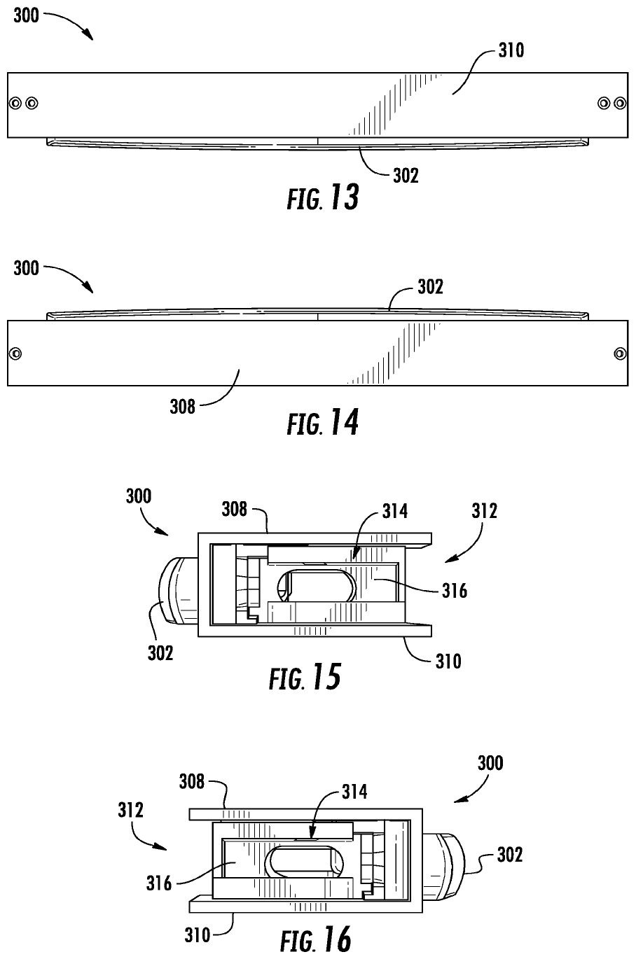

Referring now to FIGS. 10-16, a first example of the light source 300 includes a generally U-shaped housing 304 providing an exterior cover over electrical components within the housing 304. The housing 304 includes a housing front wall 306 extending vertically between a housing upper wall 308 and a housing lower wall 310. The light cover 302 extends through the opening 312 in the housing front wall 306. Optionally, the light cover 302 may have a convex curvature along its elongated direction to mimic the curvature of the lip 310.

The housing top wall 308 and bottom wall 310 are substantially planar and parallel to each other. The distance D1 between the housing top wall 308 and bottom wall 310 is less than the vertical length D2 of the lip 210 from where the lip 210 terminates at its bottom end to the point where the lip 210 downturns on its upper end.

The housing 304 has an open back section 312 and opposed open ends 314. This configuration allows the housing 304 to form a sleeve-like cavity that receives an electrical chassis 316 including the electrical components of the light source 300.

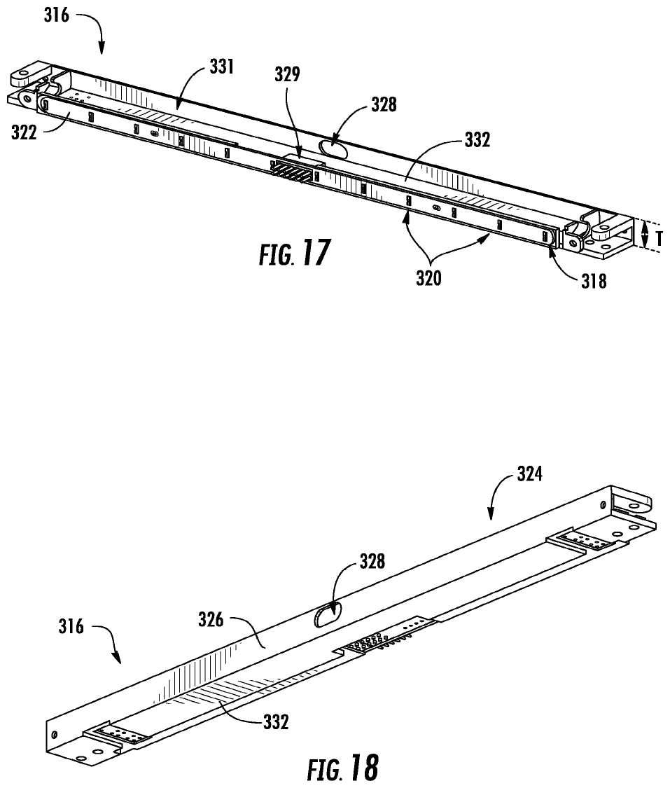

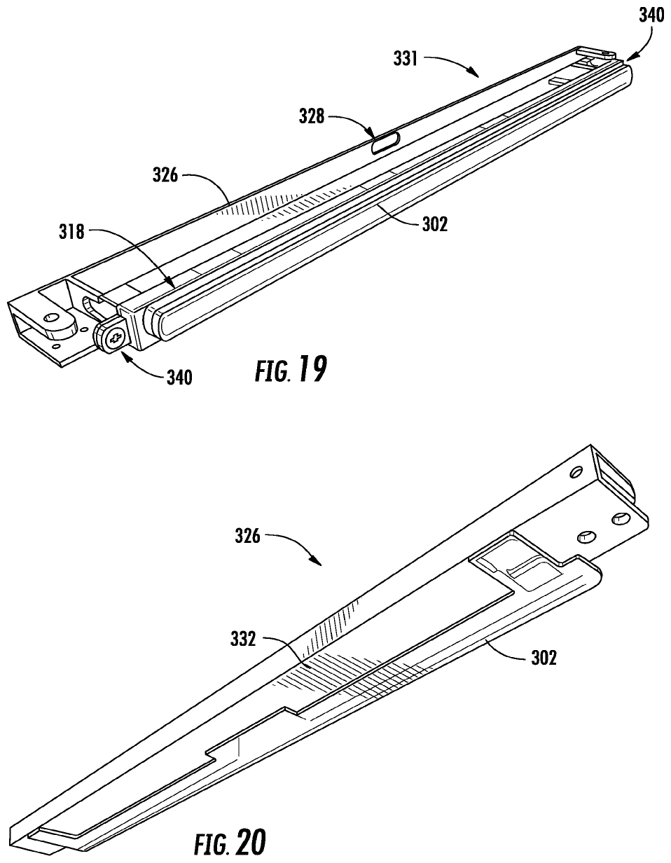

FIGS. 17 and 18 depict the electrical chassis 316 separated from the housing 304 with the light cover 302 not shown. A chassis front wall 318 supports a plurality of lights 320 arranged on a light strip 322. The lights 320 may be conventional lighting devices such as light emitting diodes (LEDs) or the like. The lights 320 may be single color or multicolor lights, depending on the user's preferences. The lights 320 are oriented to emit light through the light cover 302.

The electrical chassis 316 further includes a chassis rear wall 326 opposite the chassis front wall 318. When the housing 304 is installed, the chassis rear wall 326 at least partially closes the open back section 312 of the housing 304. The chassis rear wall 326 defines a wire receiving opening for feeding electrical wiring to the light strip 322. The electrical wiring may be plugged in to a receptacle 329 connected to the light strip 322. A central section of the electrical chassis 326 forms a channel with an open chassis top section 331 and a chassis bottom wall 332. The channel in the electrical chassis 316 is also substantially U-shaped. The channel in the chassis provides a space for electrical components such as wiring, receptacles, circuits, and the like.

The electrical chassis 316 may be installed on the step pad 200 without the housing 304 in certain example embodiments. In such a case, the vertical thickness T of the electrical chassis 316 from its uppermost point to its lowermost point is less than the thickness of the lip 310.

The light strip 322 may be an LED light strip that includes a plurality of individual LED bulbs positioned on a backing material. Wiring on or within the backing material is connected to each individual LED bulb.

FIGS. 19 and 20 depict the electrical chassis 316 with the light cover 302 attached. The light cover 302 is fastened to the chassis front wall 322 by a plurality of fasteners 340, such as, for example, screws or the like. The light cover 302 covers the lights 322 to protect them from damage. The material forming the light cover 302 is transparent or translucent so the light may shine therethrough. The same material may extend to the chassis bottom wall 332 such that it can provide a transparent or translucent window into the chassis channel.

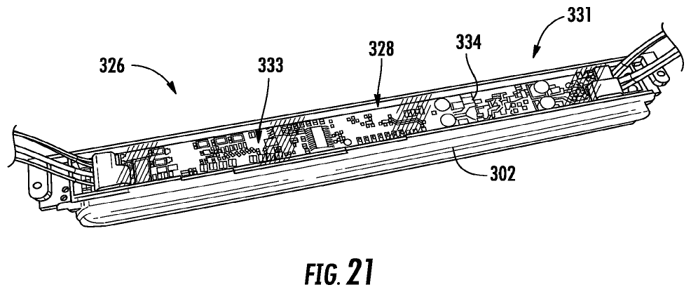

In FIG. 21, a circuit board 333 is installed in the channel in the electrical chassis 326. The circuit board 333 includes control wiring for the lights 322. In order to waterproof the circuit board 333 and lights 322, the channel may be filled over the circuit board 333 with a waterproofing material 334 such as an electrically insulating plastic or resin, including an epoxy resin for example.

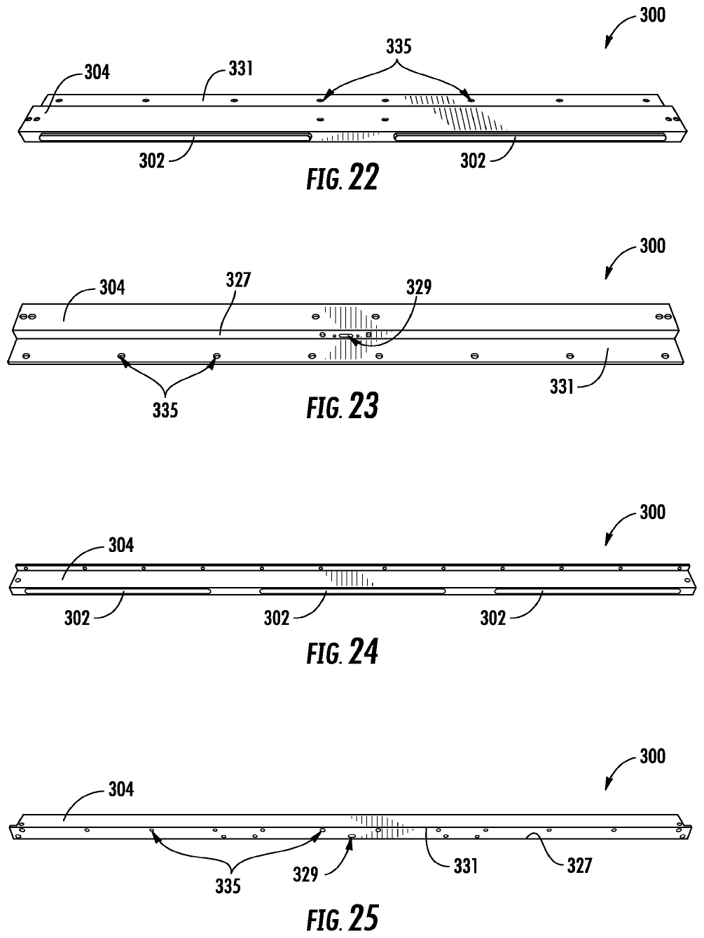

Referring now to FIGS. 22 and 23, a second example of the light source 300 includes two of the electrical chassis 326 (not visible) within a housing 304. The two light covers 302 are visible. The open back section 312 of the housing 304 is closed by a plate 327. The plate 327 defines a wire receiving opening 329 for receiving electrical wires. A connector panel 331 extends rearward from the plate 327. The connector panel 331 includes a plurality of holes 335 through which a fastener such as a bolt, screw, or the like may be inserted for attaching the light source 300 directly to a portion of a vehicle apart from the step pad 200.

Referring now to FIGS. 24 and 25, a third example of the light source 300 includes three of the electrical chassis 326 (not visible) within a housing 304. The three light covers 302 are visible. The open back section 312 of the housing 304 is closed by a plate 327. The plate 327 defines a wire receiving opening 329 for receiving electrical wires. A connector panel 331 extends upward from the plate 327. The connector panel 331 includes a plurality of holes 335 through which a fastener such as a bolt, screw, or the like may be inserted for attaching the light source 300 directly to a portion of a vehicle apart from the step pad 200.

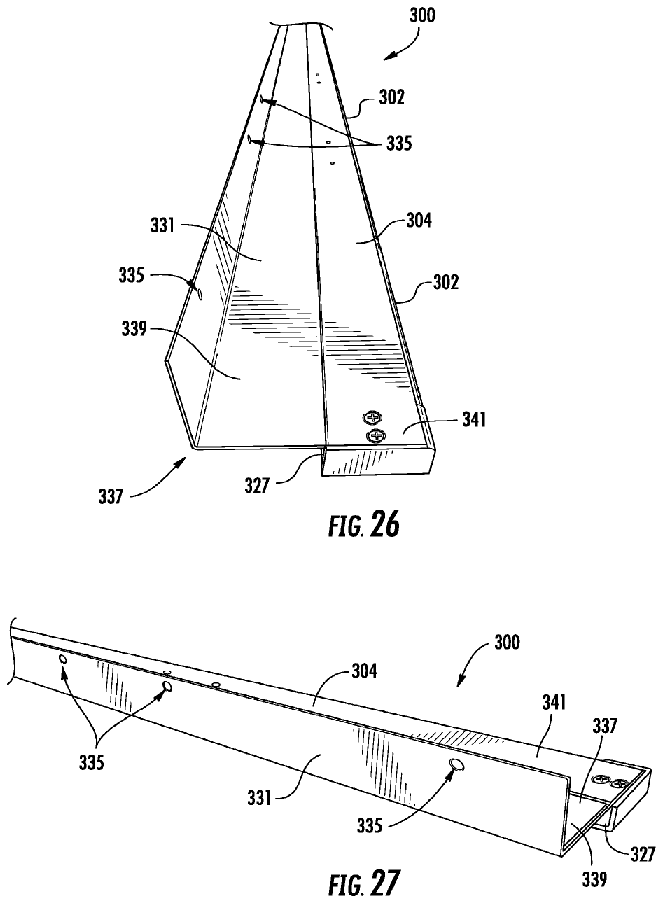

Referring now to FIGS. 26 and 27, a fourth example of the light source 300 is similar to the examples of FIGS. 22-25 and includes a housing 304 with the open back section 312 closed by a plate 327. The connector panel 327 includes a plurality of holes 335 through which a fastener such as a bolt, screw, or the like may be inserted for attaching the light source 300 directly to a portion of a vehicle apart from the step pad 200. In this example, the connector panel includes a substantially L-shaped section 337 having a first wall 339 extending substantially parallel to an upper surface 341 of the housing 304 and a second wall 343 extending substantially perpendicular to the first wall 337. The shape of the different connector panels 337 in the examples shown in FIGS. 22-27 allow for attachment to different types of vehicles or parts of vehicles.

Although the light source 300 is advantageous for use with the lighted step pad 200, it should be understood that the light source 300 may have many other uses, especially for mounting onto a vehicle.

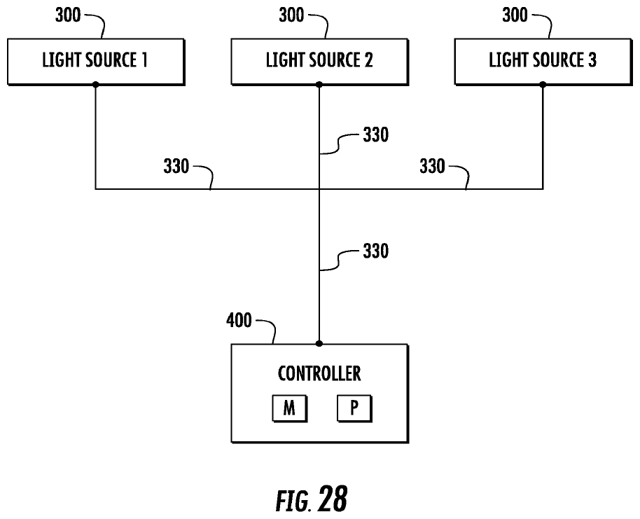

Referring to FIG. 28, a schematic diagram of three light sources 300 connected via electrical wiring 330 to a controller 400 is shown. The controller 400 is configured to turn the light sources 300 on and off. The controller 400 may include machine memory M storing program instructions that are executed by a central processing unit P for providing different lighting scheme options. The program instructions, for example, may include a lights flashing program and/or a lights continuously on program. Likewise the program instructions may determine the light color(s) used in a particular program. Electrical power to the light sources 300 and the controller 400 may be provided by the vehicle's battery and/or alternator, for example.

In another example, the light sources 300 are turned on and off in concert with the vehicle's brake lights.

If the step pad 200 is installed on an emergency vehicle, the controller 400 may be programmed to operate in concert with the vehicle's pre-existing emergency lighting system.

A method of lighting a vehicle part is now described. The method includes forming an opening in a portion of a first vehicle step pad having a stepping surface configured to permit a user to step on the stepping surface when loading objects into a vehicle on which the step pad is attached. The opening may be formed by way of, for example, cutting the opening into the step pad with conventional cutting tools, molding the opening into the step pad in a molding operation, or the like.

The method continues by positioning a light source adjacent the opening so as to emit light from the opening. The light source may be positioned adjacent the opening, for example, by attaching the light source to the step pad in such a way that light from the light source can be emitted from the opening.

Depending on the number of light sources desired, the forming step may include forming a plurality of openings in the step pad to accommodate a plurality of light sources.

The first step pad may be a replacement part for a second step pad. In a particular example, the second step pad is the unlighted step pad that was originally installed on the vehicle when it was manufactured.

An example of the light source and lighted vehicle step pad has been described in detail above and is shown in the drawings. This example is provided for illustrative purposes. The scope of possible examples is not limited to the example described here. Many modifications can be made that may not be described but still fit within the scope of the appended claims.

1. A light source comprising:
a housing forming a first channel having an upper planar wall and a lower planar wall, a housing front wall extending vertically between the upper planar wall and lower planar wall, and an open back section opposite the front wall;
a light cover positioned at the housing front wall; and
an electrical chassis positioned within the channel, the electrical chassis including a chassis rear wall that at least partially closes the open back section, a chassis front wall supporting a plurality of LEDs oriented to emit light through the light cover, the electrical chassis forming a second channel within the first channel, the second channel including electronics.

2. The light source of claim 1, wherein the light cover is connected directly to the electrical chassis and extends through the front wall.

3. The light source of claim 1, wherein the chassis rear wall defines a wire receiving opening.

4. The light source of claim 1, wherein the electrical chassis includes an open top section.

5. The light source of claim 1, wherein the first channel and second channel are both generally U-shaped.
